(19) United States
(12) Patent Application Publication
(10) Pub. No.: US 2008/0149018 A1
(43) Pub. Date: Jun. 26, 2008

(54) Noisemaker pennant

(76) Inventor: Katherine R. Sherrod, Norfolk, VA (US)

Correspondence Address: LITMAN LAW OFFICES, LTD., P.O. BOX 15035, CRYSTAL CITY STATION, ARLINGTON, VA, 22215, US

(21) Appl. No.: 11/642,649

(22) Filed: Dec. 21, 2006

(51) Int. Cl. G09F 17/00

(52) U.S. Cl. 116/173

(57) ABSTRACT

The noisemaker pennant is a combination pennant or flag and a noisemaker device that enables the sports fan to simultaneously express his or her emotions at an event both visually and audibly. Waving the present noisemaker pennant serves to display the pennant or flag thereon, while simultaneously activating the noisemaker device attached thereto. The noisemaker pennant may have various types of pennants, flags, banners, etc. formed of relatively thin, flexible material, with a sports team logo, player's name, political symbol, etc., displayed thereon. The noisemaker portion may be any of various devices, including, but not limited to, clappers, ratcheting devices, bells, whistles, etc. The noisemaker portion and/or the pennant may be removably secured to the staff, to allow the user to interchangeably install different noisemakers with the pennant or flag. A handgrip is provided on the staff opposite the noisemaker end thereof.

### BACKGROUND OF THE INVENTION

1. Field of the Invention

The present invention relates generally to novelty signaling devices and the like, and more particularly to a noisemaker pennant for use at sports events and conventions and the like.

2. Description of Related Art

It has been customary for years for ardent sports fans to express their emotions at various sports competitions. This is typically accomplished by applauding, cheering, and/or otherwise expressing one's emotions when a particularly desirable result occurs on the playing field, track, etc. In many instances, fans will purchase a pennant or the like to wave while cheering their favorite player or team on.

It is customary for many fans to cheer or otherwise express their feelings audibly for their team or player, perhaps while simultaneously waving a banner, flag, etc. In many instances, fans show their pleasure by applauding a particularly good play or other favorable situation or result on the field. However, it is impossible to use one's hands to applaud while simultaneously waving a flag, pennant, banner, or some other visual device, particularly if some form of food or refreshment, or perhaps a program or other article, is being held in the other hand as well. Much the same is true at various conventions and similar gatherings, when participants wish to express their appreciation of a speaker, activity, etc.

Thus, a noisemaker pennant solving the aforementioned problems is desired.

### SUMMARY OF THE INVENTION

The noisemaker pennant is a pennant, flag, banner, or the like in combination with a noisemaking device, e.g., a “clapper” type device, ratcheting or rattling noisemaker, bell, etc. The noisemaker pennant enables the sports fan to root for his or her team simultaneously using both visual means by waving the pennant or banner and audio means by shaking, turning, or otherwise operating the attached sound-producing device. The flag or pennant portion of the noisemaker pennant may comprise any of a number of different forms, so long as the pennant is a relatively lightweight, thin, and flexible material adapted to be waved and displayed in such a manner. It will be understood that the term “pennant” as used herein, includes flags, banners, and similar devices having sports team logos, athletes' or participants' names, numbers, teams, etc. thereon, symbols common to and recognized in the sport or other activity, political logos and symbols, etc., as desired.

The noisemaker portion of the device may comprise any of a number of different manually actuated devices (bells, clappers, ratcheting or other types of noisemakers, whistles, etc.). The noisemaking device is secured to the opposite end of the staff from the handgrip or handle portion, and produces a sound whenever it is shaken, spun, rotated, or otherwise vigorously moved simultaneously with waving or other movement of the pennant on the same staff. A handgrip is preferably provided along the staff, opposite the noisemaker end of the staff.

Preferably, the noisemaker detachably secured to the staff for removal and replacement. This allows the owner or user of the device to exchange the noisemaker portion in order to install different types of noisemakers on the end of the staff for use with different pennants. The noisemaker pennant provides various means of temporarily and removably securing a variety of noisemaking devices to the end of the pennant staff. Alternatively, the pennant may be removably secured to the staff for interchange of different pennants.

These and other features of the present invention will become readily apparent upon further review of the following specification and drawings.

### BRIEF DESCRIPTION OF THE DRAWINGS

FIG. 1 is an environmental view showing a large number of fans waving and using the present noisemaker pennant in a stadium environment.

FIG. 2 is an exploded perspective view of a first embodiment of the present noisemaker pennant, illustrating the system used for removably securing the noisemaker device to the staff portion.

FIG. 3A is an exploded elevation view in partial section of the noisemaker and pennant staff attachment means of the noisemaker pennant embodiment of FIG. 2, showing details thereof.

FIG. 3B is an exploded elevation view in partial section of an alternate embodiment means for removably securing the noisemaker device to the pennant staff.

FIG. 4 is an exploded perspective view illustrating the interchangeability of a series of different noisemaker devices with different pennant or flag configurations.

FIGS. 5A, 5B, 5C and 5D illustrate four different clapper-type noisemaker configurations disposed upon the noisemaker installation end of a staff.

Similar reference characters denote corresponding features consistently throughout the attached drawings.

### DETAILED DESCRIPTION OF THE PREFERRED EMBODIMENTS

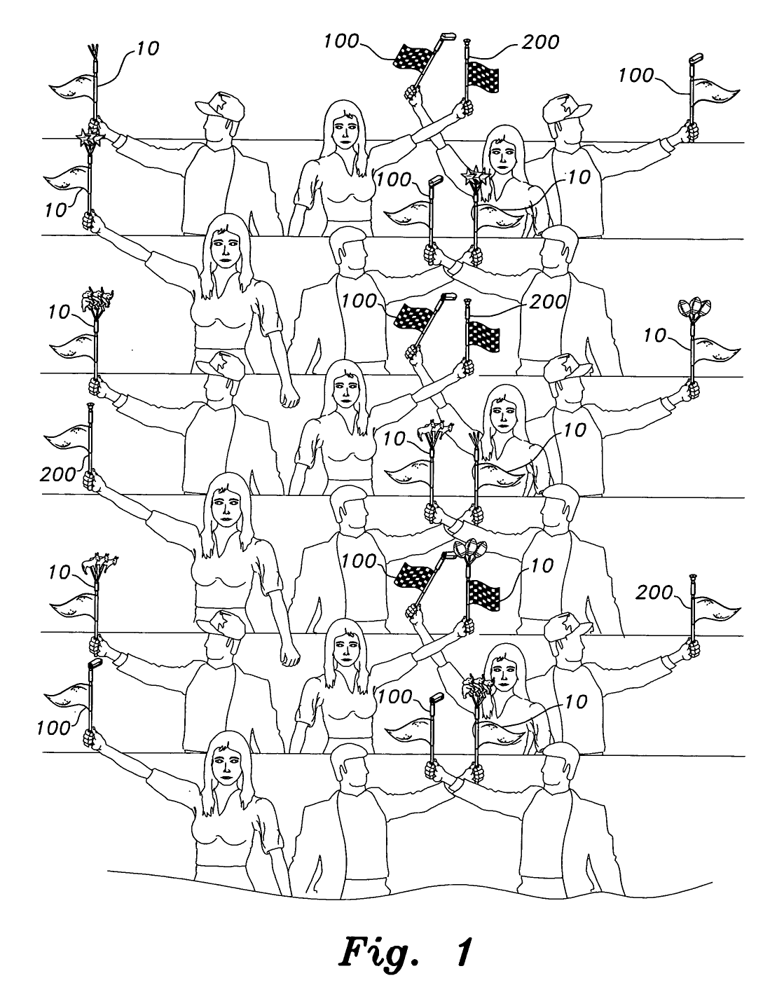

The present invention comprises various embodiments of a combination noisemaker pennant device for use by fans at sporting events, political conventions, and the like. FIG. 1 of the drawings illustrates a series of different embodiments of the noisemaker pennant in use by fans at a sporting event, with the different embodiments of FIG. 1 respectively designated as noisemaker pennants 10, 100, and 200, which are illustrated in further detail in the following drawings and described in greater detail further below. The noisemaker pennants shown in FIG. 1 are exemplary, and it will be understood that a great number of additional embodiments may be developed in accordance with the teachings of the present invention.

The noisemaker pennant generally comprises a flag, pennant, banner, or the like formed of a relatively lightweight and flexible sheet of material (fabric, plastic sheet, etc.), which is attached to a staff, and a noisemaker device attached to and extending from one end of the staff. Both the pennant and noisemaker may be permanently secured to the staff, but preferably at least the noisemaker component is removably secured to the upper or distal end of the staff so that the user may interchange different noisemaking devices with a given pennant and staff as desired. The pennant or flag portion may also be removably secured to the staff.

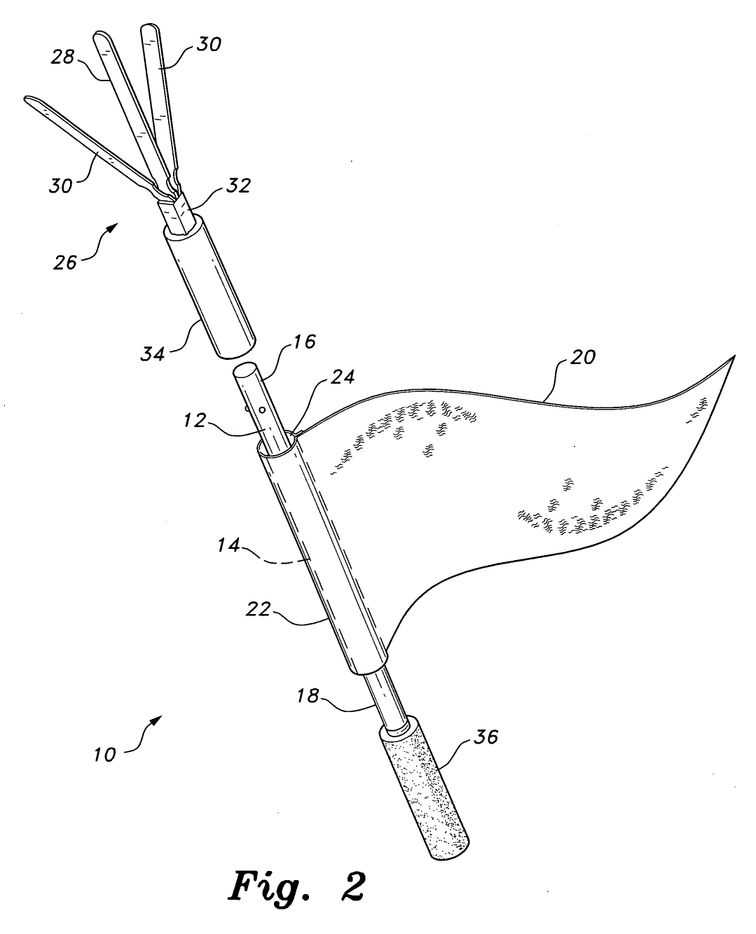

FIG. 2 provides a detailed illustration of the noisemaker pennant 10 shown generally in FIG. 1, and illustrates its various components and their interrelationships. The noisemaker pennant 10 comprises an elongate staff 12, which may be formed of wood, plastic rod or tubing, or other suitable material. The staff 12 has a pennant attachment portion 14, which is generally oriented upwardly when the device 10 is in use, and a distal noisemaker attachment end 16 preferably immediately beyond the pennant attachment portion 14, with a central staff portion 18 depending from the pennant attachment portion 14. The central portion 18 need not be excessively long, and in fact the noisemaker and pennant components may extend over or cover nearly all of the staff 12, so that little or none of the central length 18 is visible when the device is assembled in order to provide a compact unit.

A pennant, flag, banner, etc. 20 is secured to the pennant attachment portion 14 of the rod or staff 12. This pennant 20 may comprise any of a number of different configurations (triangular, square, etc.), with any or all of the configurations possibly including some form of indicia thereon, e.g., sports team emblems or logos, player names and numbers, signaling flags used in auto racing, political symbols, etc. As noted further above, it will be understood that the term “pennant,” as used herein, is intended to cover any relatively thin, flexible or flaccid sheet of material, which may be applied to the pennant attachment portion 14 of the staff 12 and extend therefrom in order to be waved or displayed by a sports fan or user of the noisemaker pennant 10.

The pennant 20 may be permanently secured to the staff 12, e.g., by conventional staples, adhesive, etc. Alternatively, the pennant 20 may be removably secured to the staff 12. The pennant 20 may have a base or staff attachment end 22 comprising or including a sleeve 24, which is configured to fit closely over the pennant attachment portion 14 of the staff 12. Other removable attachment means, e.g., conventional clips, clamps, snaps, etc., may be provided for attaching the pennant 20 to the staff 12.

A noisemaker 26 is removably attached or secured to the noisemaker attachment end 16 of the pennant rod or staff 12. The noisemaker 26 component of the noisemaker pennant 10 of FIGS. 1 and 2 comprises a “clapper” type device, having a relatively fixed central paddle 28 with a pair of hinged vanes 30 extending to opposite sides thereof. The vanes 30 slap against the central paddle 28 when the noisemaker pennant 10 is waved or oscillated, thereby simultaneously providing a visual display in the form of the waving pennant 20 and an audible component emanating from the noisemaker device 26. Any number of alternative noisemaker devices or configurations may be attached to the staff 12 of the noisemaker pennant 10, depending upon the sound desired, cost objectives, etc. A few such noisemaker alternatives are illustrated in the other embodiments shown in FIG. 1 of the drawings and in subsequent drawings discussed in detail further below.

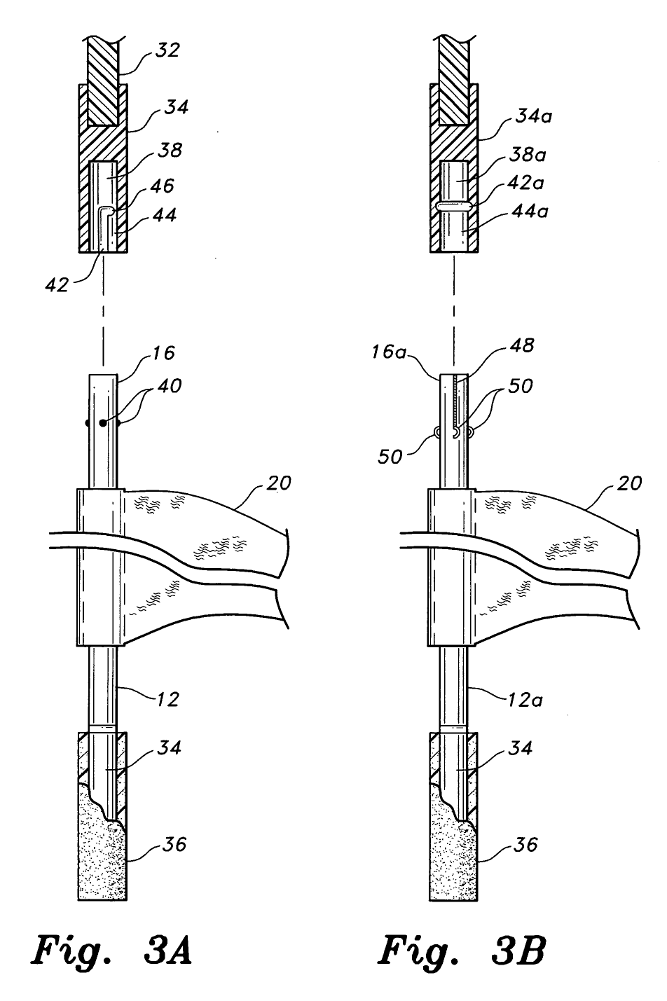

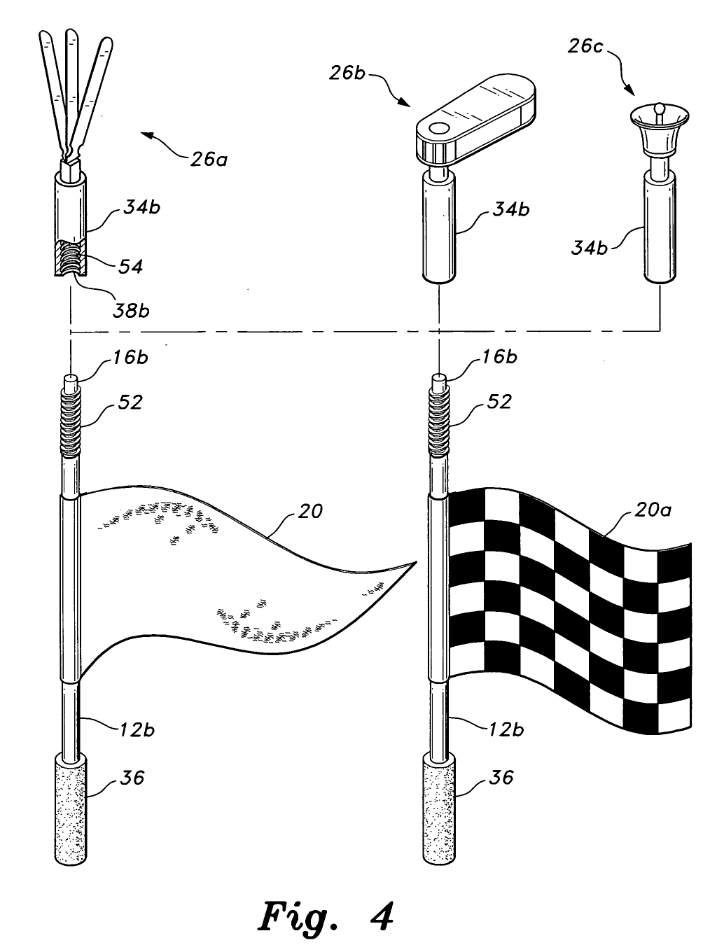

The noisemaker 26 has a base 32 with a generally cylindrical staff attachment portion or end 34 extending axially therefrom. The staff attachment end portion 34 of the noisemaker 26 includes a socket 38 formed therein adapted for the removable installation of the noisemaker attachment end 16 of the pennant staff 12 therein, as shown in FIG. 3A. In the noisemaker pennant 10 of FIGS. 1, 2, and 3A, the noisemaker attachment end 16 of the staff 12 includes at least one protuberance 40 (and preferably a plurality of such protuberances 40) extending radially therefrom. A corresponding slot or slots 42 is formed axially in the inner wall 44 of the staff attachment socket 38, with each of the slots 42 having a circumferential extension 46 at its base to form a generally L-shaped configuration, as shown in detail in FIG. 3A.

The noisemaker 26 is removably secured to the pennant staff 12 by inserting the noisemaker attachment end 16 of the staff 12 into the noisemaker socket 38 with the staff protuberance(s) 40 aligned with the noisemaker socket slot(s) 42, and twisting the staff 12 to engage the protuberance(s) 40 with the right-angled circumferential slot extension(s) 46 at the bottom of each slot 42. Removal of the noisemaker device 26 from the staff 12 is accomplished by reversing the above operation.

FIG. 3B illustrates an alternative means of attaching the noisemaker device to the end of the pennant staff. In FIG. 3B, a pennant staff 12a is essentially identical to the staff 12 of FIGS. 2 and 3A, with the exception of the resilient spring element(s) 48 disposed within slots along the noisemaker attachment end 16a thereof. These spring element(s) 48 each have a protruding rounded end 50 extending radially from the noisemaker attachment end 16a of the staff 12, with the spring 48 urging the end 50 outwardly, similar to devices used to lock telescoping extensions in place in an umbrella. The staff attachment fitting or end 34a of the corresponding noisemaker device includes an axial socket 38a therein, with the socket 38a having a circumferential groove 42a formed about its internal wall 44a. The spring protrusion(s) 50 and spring element(s) 48 are compressed inwardly by the socket wall 44a of the noisemaker attachment fitting 34a when the noisemaker attachment end 16a of the staff 12a is inserted into the noisemaker socket 38a, with the spring protrusions 50 expanding or springing radially outwardly to engage the circumferential groove 42a of the socket 38a when the end 16a of the staff 12a is fully seated within the noisemaker socket 38a. Separation of the staff 12a from the noisemaker socket 38a is easily accomplished by a moderate pull or tensile force, thereby causing the spring protrusion(s) 50 to be compressed by the interior wall 44a of the socket 38a to allow the noisemaker attachment end 16a of the staff 12a to be withdrawn from the noisemaker socket 38a.

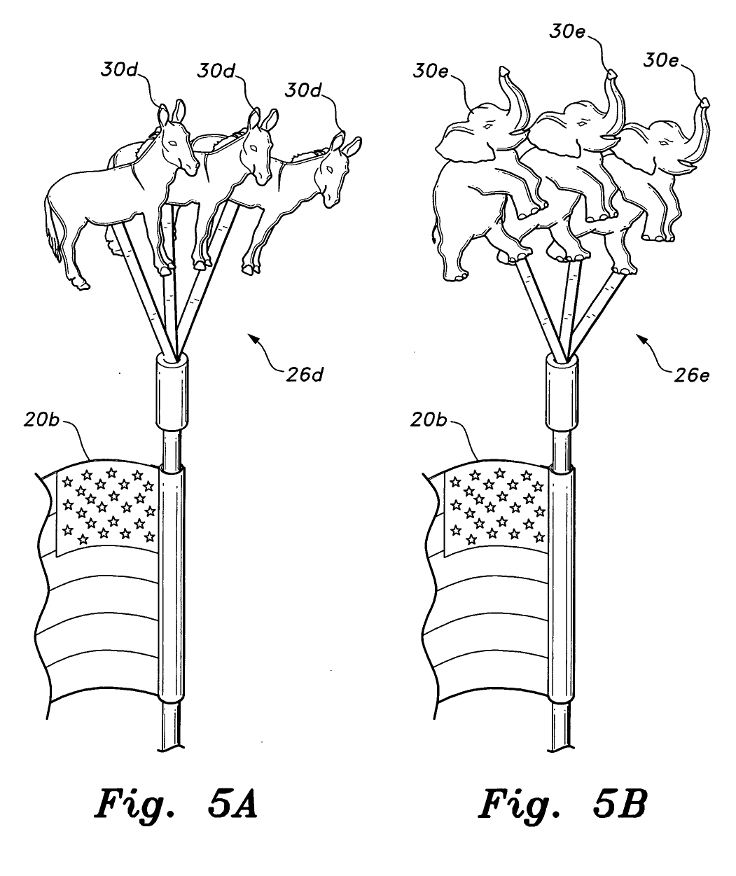

FIG. 4 of the drawings illustrates further embodiments of the noisemaker pennant, and further illustrates the interchangeability of the various components thereof when the device is provided with compatible attachment means between components. In the left side of FIG. 4, a staff 12b includes a pennant 20 extending therefrom, with the noisemaker attachment end 16b having external threads 52 thereon. The staff attachment portion 34b of the “clapper” type noisemaker 26a has a socket 38b including internal threads 54 defined therein. The noisemaker 26a may thus be threaded onto or removed from the threaded noisemaker attachment end 16b of the staff 12b to exchange noisemakers.

Any of the various pennant staff and noisemaker components illustrated in FIG. 4 may be assembled with one another in any desired combination due to their common mating threaded attachments. For example, the staff 12b illustrated to the right side of FIG. 4 is identical to the staff 12b to the left side of FIG. 4, with the only difference being the type of flag or pennant installed thereon. While the left side staff 12b has a generally triangular pennant 20 removably or permanently secured thereto, the right side staff 12b includes a rectangular checkered flag 20a, as used to indicate the end of an auto race, installed thereon. The two different pennants and flags 20 and 20a may be interchangeably installed upon either of the flag or pennant staffs 12b, or upon the staffs 12 or 12a of other drawings, if so desired.

Similarly, the different types of noisemaker devices illustrated in the upper portion of FIG. 4 may be removably secured to either of the pennant or flag staffs 12b of FIG. 4. Each of the different noisemakers includes a staff attachment component 34b extending therefrom, with each staff attachment including a socket 38b having internal threads 54 therein (as shown for the clapper type noisemaker 26a to the left side of FIG. 4) to attach to the mating threads 52 of either of the staffs 12b of illustrated in FIG. 4. However, a different type of noisemaker extends from each of the identical noisemaker attachment elements 34b. The noisemaker 26a to the upper left portion of FIG. 4 is a “clapper” type, as discussed further above. The noisemaker 26b in the upper center of FIG. 4 comprises a rotating ratchet type device, which produces a noise when rotated or spun. Alternatively, the noisemaker 26c to the upper right of FIG. 4 comprises a bell. It will be seen that other types of noisemakers (e.g., whistles, electronic devices, etc.) may be removably or permanently secured to any of the staff components and associated flags or pennants merely by providing mating attachment means between the noisemaker device and corresponding flag or pennant staff. Any of the staffs 12, 12a, or 12b of FIGS. 1 through 4 may also include a padded or resilient handgrip 36 disposed upon the handle portion 34 thereof (shown in FIGS. 3A and 3B) opposite the noisemaker attachment end 16, 16a, or 16b.

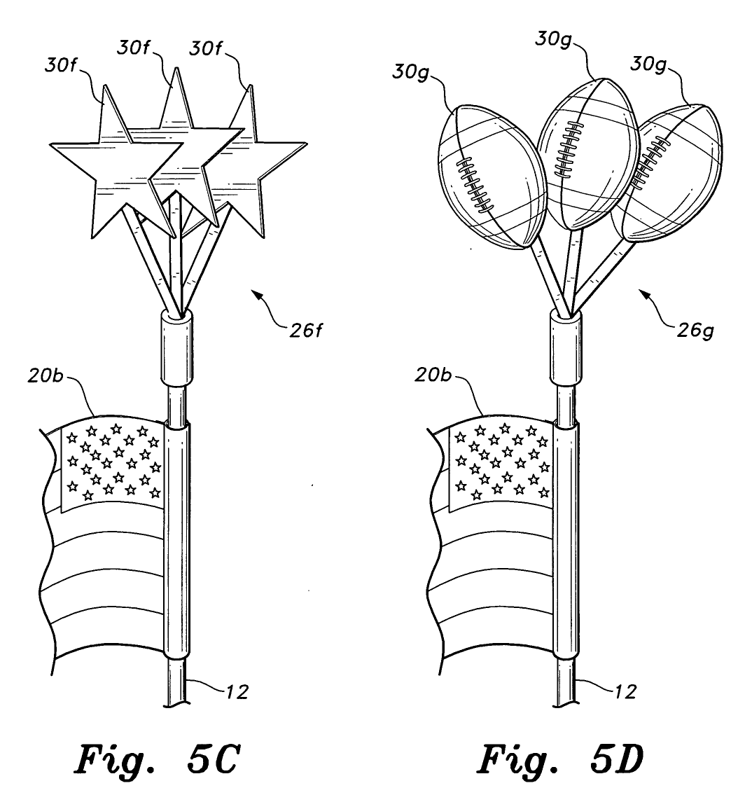

The noisemaker pennant may be used to show support in various other activities, such as political rallies and conventions, as well as at sporting events, as noted further above. FIGS. 5A through 5D provide illustrations of exemplary noisemaker and pennant configurations that might be popular at such events. For example, the clapper type noisemaker device 26d of FIG. 5A is similar to the clapper noisemaker 26 and 26a respectively of FIGS. 2 and 4, but includes vanes 30d configured to resemble the donkey symbolizing the Democratic party. Conversely, the clapper noisemaker 26e of FIG. 5B may comprise vanes 30e configured to represent the elephant of the Republican Party.

FIGS. 5C and 5D illustrate still further examples of such clapper type noisemaker configurations. In the example of FIG. 5C, the clapper noisemaker 26f has clapper elements 30f comprising five pointed stars, while the noisemaker 26g of FIG. 5D has clapper elements 30g resembling American footballs. It will be seen that the specific shape or configuration of the clapper elements may be formed in any practicable manner desired to represent a political party or other organization, sports team or symbol, etc. In a like manner, the flag or pennant disposed upon the staff 12 (or other staff, depending upon the noisemaker attachment principle) may be any practicable configuration or design. In the examples of FIGS. 5A through 5D, an American flag 20b is shown.

In conclusion, the noisemaker pennant provides an enjoyable means for a sports fan to express his or her emotions at a sporting event or the like, or for a participant at a political event to show his or her support. The fan or participant may purchase or modify the associated pennant, flag, banner, etc. to display his or her favorite team emblem, logo, player name and/or number, political party or affiliation, etc. The inclusion of a noisemaking device with the flag or pennant staff allows the fan or participant to produce a sound while simultaneously waving the flag or banner to express themselves visually. The great versatility of the noisemaker pennant, with its ability to provide different sounds depending upon the type of noisemaking device installed therewith, will thus find great favor among sports fans and participants in various events everywhere.

It is to be understood that the present invention is not limited to the embodiments described above, but encompasses any and all embodiments within the scope of the following claims.

I claim:

1. A noisemaker pennant, comprising:
an elongate staff having a noisemaker attachment end, a pennant attachment portion adjacent the noisemaker attachment end, and a handle portion opposite the noisemaker attachment end;
a pennant formed of a thin, flexible sheet of material attached to, and extending from, the pennant attachment portion of the staff; and
a noisemaker device attached to, and extending from, the noisemaker attachment end of the staff.

2. The noisemaker pennant according to claim 1, further including a resilient handgrip disposed upon the handle portion of said staff.

3. The noisemaker pennant according to claim 1, wherein said pennant is removably secured to the pennant attachment portion of said staff, said pennant having a staff attachment end having a sleeve removably installed over the pennant attachment portion of said staff.

4. The noisemaker pennant according to claim 1, wherein said noisemaker device is removably attached to the noisemaker attachment end of said staff.

5. The noisemaker pennant according to claim 4, wherein said noisemaker device has a staff attachment socket formed axially therein, the socket including an internal wall having at least one L-shaped slot formed therein, the noisemaker pennant further including at least one protuberance extending radially from the noisemaker attachment end of said staff. the protuberance being slidable in both legs of the L-shaped slot in order to removably attach said noisemaker device to said staff.

6. The noisemaker pennant according to claim 4, wherein said noisemaker device has a staff attachment socket formed axially therein, the socket including an internal wall having a circumferential groove formed therein, the noisemaker pennant further including at least one resilient spring element extending radially from the noisemaker attachment end of said staff, the spring element resiliently engaging the circumferential groove in order to removably attach said noisemaker device to said staff.

7. The noisemaker pennant according to claim 4, wherein said noisemaker device has a staff attachment socket formed axially therein, the socket being internally threaded, the noisemaker attachment end of said staff being externally threaded, whereby said noisemaker device is removably attached to said staff by threading the noisemaker attachment end of said staff into the staff attachment socket of said noisemaker device.

8. The noisemaker pennant according to claim 1, wherein said noisemaker device comprises a clapper.

9. The noisemaker pennant according to claim 1, wherein said noisemaker device comprises a rotating ratchet device.

10. The noisemaker pennant according to claim 1, wherein said noisemaker device comprises a bell.

11. The noisemaker pennant according to claim 1, wherein said pennant is formed from sheet material selected from the group consisting of plastic and fabric.

12. A noisemaker pennant, comprising:
an elongate staff having a noisemaker attachment end, a pennant attachment portion adjacent the noisemaker attachment end, and a handle portion opposite the noisemaker attachment end;
a pennant formed of a thin, flexible sheet of material attached to, and extending from, the pennant attachment portion of the staff; and
a noisemaker device removably attached to, and extending from, the noisemaker attachment end of the staff.

13. The noisemaker pennant according to claim 12, further including a resilient handgrip disposed upon the handle portion of said staff.

14. The noisemaker pennant according to claim 12, wherein said pennant is removably secured to the pennant attachment portion of said staff, said pennant having a staff attachment end having a sleeve removably installed over the pennant attachment portion of said staff.

15. The noisemaker pennant according to claim 12, wherein said noisemaker device has a staff attachment socket formed axially therein, the socket including an internal wall having at least one L-shaped slot formed therein, the noisemaker pennant further including at least one protuberance extending radially from the noisemaker attachment end of said staff. the protuberance being slidable in both legs of the L-shaped slot in order to removably attach said noisemaker device to said staff.

16. The noisemaker pennant according to claim 12, wherein said noisemaker device has a staff attachment socket formed axially therein, the socket including an internal wall having a circumferential groove formed therein, the noisemaker pennant further including at least one resilient spring element extending radially from the noisemaker attachment end of said staff, the spring element resiliently engaging the circumferential groove in order to removably attach said noisemaker device to said staff.

17. The noisemaker pennant according to claim 12, wherein said noisemaker device has a staff attachment socket formed axially therein, the socket being internally threaded, the noisemaker attachment end of said staff being externally threaded, whereby said noisemaker device is removably attached to said staff by threading the noisemaker attachment end of said staff into the staff attachment socket of said noisemaker device.

18. The noisemaker pennant according to claim 12, wherein said noisemaker device comprises a clapper.

19. The noisemaker pennant according to claim 12, wherein said noisemaker device comprises a rotating ratchet device.

20. The noisemaker pennant according to claim 12, wherein said noisemaker device comprises a bell.
